(19) United States
(12) Patent Application Publication
(10) Pub. No.: US 2003/0042101 A1
(43) Pub. Date: Mar. 6, 2003

(54) Freewheel hub device

(76) Inventor: Shu-Chen Juan, Taipei (TW)

Correspondence Address: SHU-CHEN JUAN, 235 Chung - Ho, Box 8-24, Taipei, TW

(21) Appl. No.: 10/059,975

(22) Filed: Jan. 30, 2002

(30) Foreign Application Priority Data
Aug. 28, 2001 (TW) 090214882

(51) Int. Cl. F16D 41/30

(52) U.S. Cl. 192/64; 192/46; 192/110 B; 301/110.5

(57) ABSTRACT

A freewheel hub device comprises a spindle. A hub, a ratchet, a freewheel, an annular cover, and a sealing washer are sequentially arranged along the spindle. A flange extends from the freewheel at a position with respect to the inner lateral side of the hub. A bearing encloses the flange so as to position the ratchet. The recess is installed at another end of the hub. An inner periphery of the recess is installed with a plurality of retaining grooves and first texture recesses. An inner side of the recess is arranged with a ratchet ring. The flange extending from the freewheel is engaged with a positioning ratchet pawl. The ratchet ring is installed with a groove. After the bearing and ratchet are engaged with the flange. The flange and the ratchet ring are installed in the recess of the hub.

### BACKGROUND OF THE INVENTION

1) Field of the Invention

The present invention relates to freewheel hub devices, the rotation of the freewheel hub is improved and strength of the spindle is enhanced so that it is difficult to deform the hub.

2) Description of the Prior Art

A conventional freewheel hub device, referring to FIG. 1 and FIG. 2, is typically comprised of a spindle 2. Moreover, a hub 3, a ratchet 4, a freewheel 5, an annular cover 6, and a sealing washer 7 are sequentially arranged along the spindle.

The hub 3 has a groove 31 in one end for installing a bearing 32. A fastening component 33 is installed at an outer portion to secure the bearing 32 in position. A recess 34 is disposed in the other end. A threaded section 341 is formed on the inner periphery of the recess 34 for fastening a ratchet ring 35. A groove 342 is formed at the lower wall of the recess 34 for installing a bearing 36.

One end of the ratchet 4 has a threaded section 41 and another end thereof is an enlarged end. An outer end of the enlarged end is installed with plurality of ratchet pawls 42 which can move upwards and downwards. for engaging the ratchet 351 in the ratchet wheel 35.

The freewheel 5 has a groove 51 aligned with the end portion of the ratchet mechanism 4. A threaded section 52 is formed at an inner side thereof, enabling the fastening of the threaded section 41 of the ratchet 4 into the threaded section 52 until the ratchet mechanism 4 is tightened and stopped against the lower wall of the of the groove 51. The freewheel 5 has a groove 53 formed at another end of the freewheel such that two bearings 54 and 55 are formed with a groove 53. A fastening component 56 serves to fix the bearing components in position.

The annular cover 6 and the sealing washer 7 are installed in the end opening of the hub 3.

The above structure enables the conventional freewheel hub to rotate smoothly.

In the structure, bearings 31, 36, 54 and 55 cause the freewheel hub to rotate smoothly. Since the bearings 31 and 35 are situated at the two interior ends of the hub 3 and the bearings 54 and 55 are situated in the groove 53 at another end of the freewheel 5. Thereby, in application, smooth rotation is effectively achieved. However, after the completed freewheel hub and cogs (not shown) is installed on a bicycle, one end of the freewheel 5 with respect to the hub 3 is screwedly fastened to the ratchet 4 and finally is engaged to the hub 3. But since the engagement is a prior art way, in the engaging place, the whole hub 3 is assembled to a bicycle. A position between the freewheel 5 and the hub 3 suffering from a largest force is easily formed with a gap as the bicycle moves. Thereby, the spindle 3 will bend so that the whole hub 3 can not operate smoothly.

### SUMMARY OF THE INVENTION

Therefore, the primary objective of the present invention is to provide a freewheel hub device having a spindle, further a hub, a ratchet, a freewheel, an annular cover, and a sealing washer being sequentially arranged along the spindle.

One lateral side of the hub has a first groove for installing a first bearing; a first fastening component is installed at an outer portion for securing the first bearing in position; a first recess is disposed in the other end.

The ratchet consists of a plurality of first pawls which are capable of moving upwards and downwards.

The freewheel has a second groove formed at a position with respect to an inner side of the ratchet for installing a second bearing; a second fastening component serves for securing the second bearing in position.

The annular cover and the sealing washer are installed at an opening of the hub.

A flange extends from the freewheel at a position with respect to the inner lateral side of the hub; a third bearing encloses an outer side of the flange so as to position the ratchet. The recess is installed at another end of the hub; and an inner periphery of the recess is installed with a plurality of retaining grooves and first texture recesses. An inner side of the recess is arranged with a ratchet ring which has a plurality of matching ridges and second texture recesses at an outer circumference thereof. The flange extending from the freewheel at the position with respect to the inner lateral side of the hub is engaged with a positioning ratchet pawl. The ratchet ring is installed with a third groove; after the third bearing and ratchet are engaged with the flange at a front end of the freewheel. The flange at the front end of the freewheel and the ratchet ring are installed in the recess of the hub.

Thereby, the cost for bearings is reduced and moreover, the weight is decreased. As a result, in practical operation, the hub rotates smoothly and the strength of the spindle is increased so that it is difficult to deform the spindle.

To enable a further understanding of the structural features and other operational details of the present invention, the brief description of the drawings below is followed by the detailed description of the invention.

### BRIEF DESCRIPTION OF THE DRAWINGS

FIG. 1 is an exploded view of a conventional freewheel hub device.

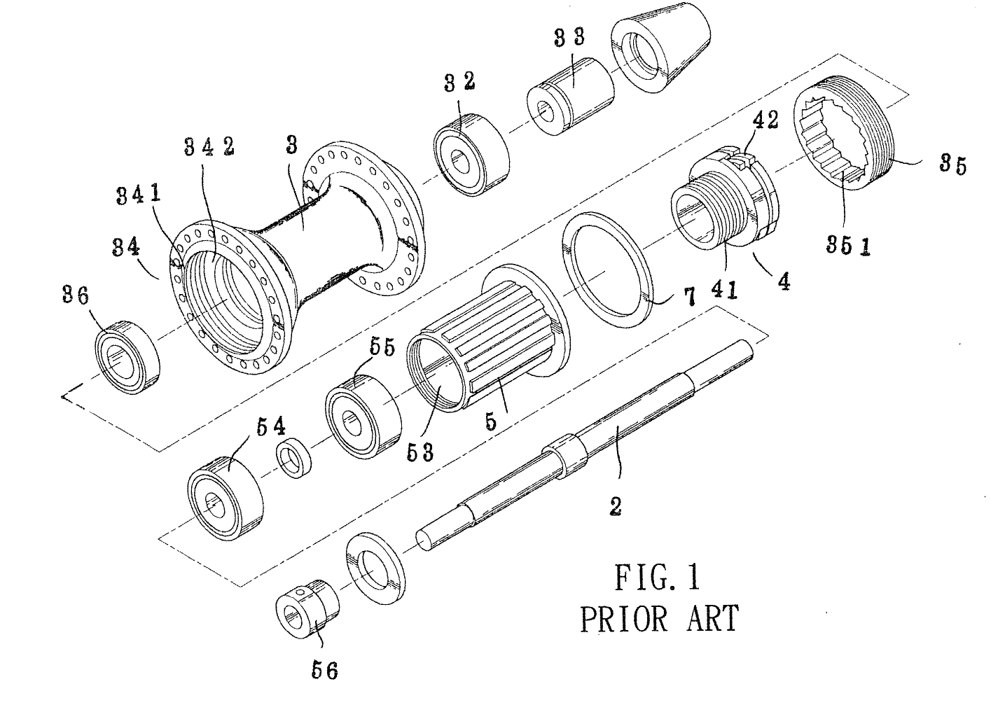

FIG. 2 is a cross-sectional view of the conventional freewheel hub device.

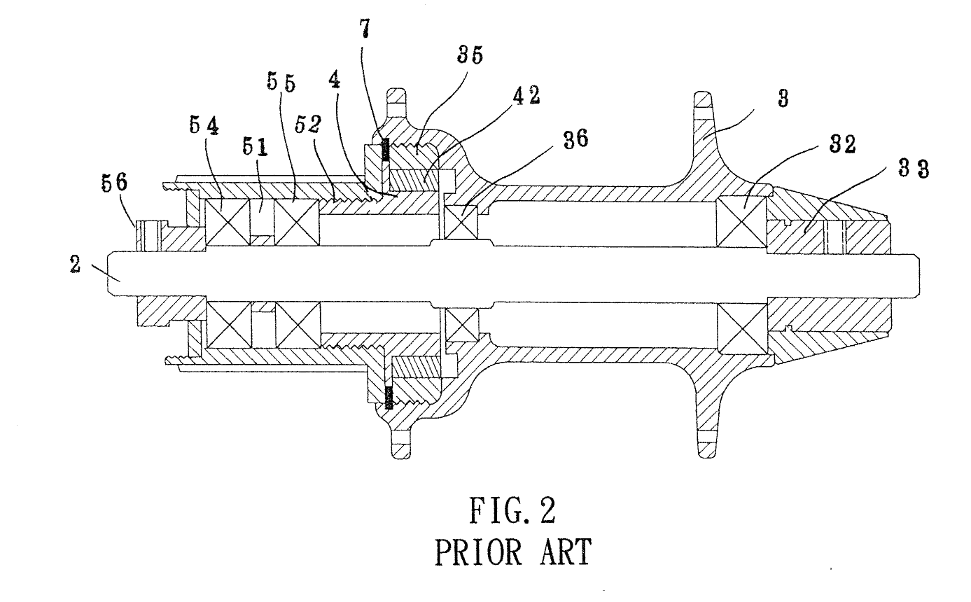

FIG. 3 is an exploded view of the freewheel hub device of the present invention.

FIG. 4 is a cross-sectional view of the freewheel hub device of the present invention.

FIG. 5 is a cross-sectional view of the feeewheel hub device of another embodiment of the present invention.

### DETAILED DESCRIPTION OF THE INVENTION

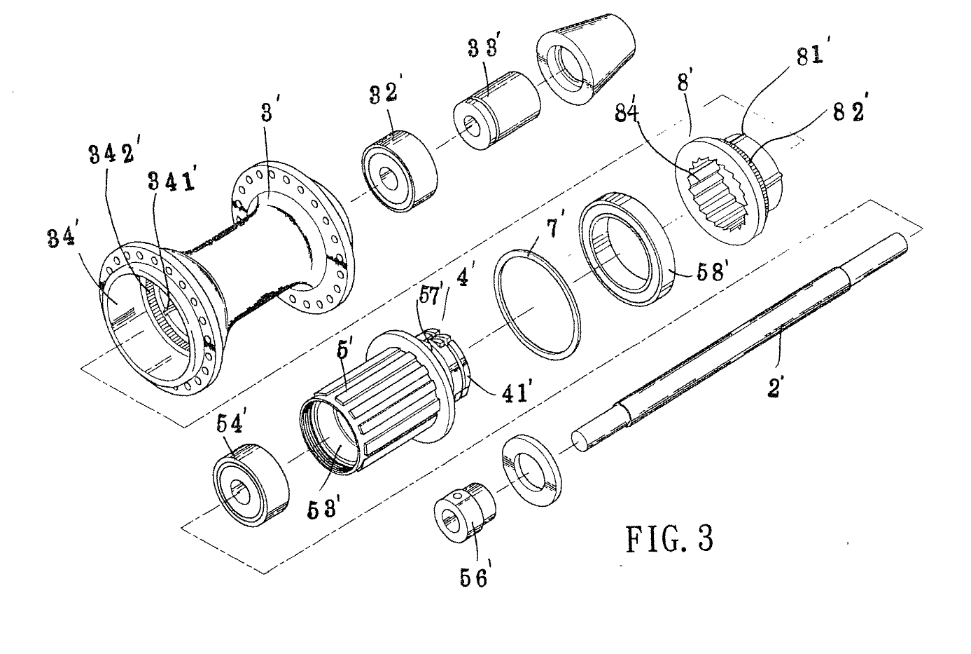

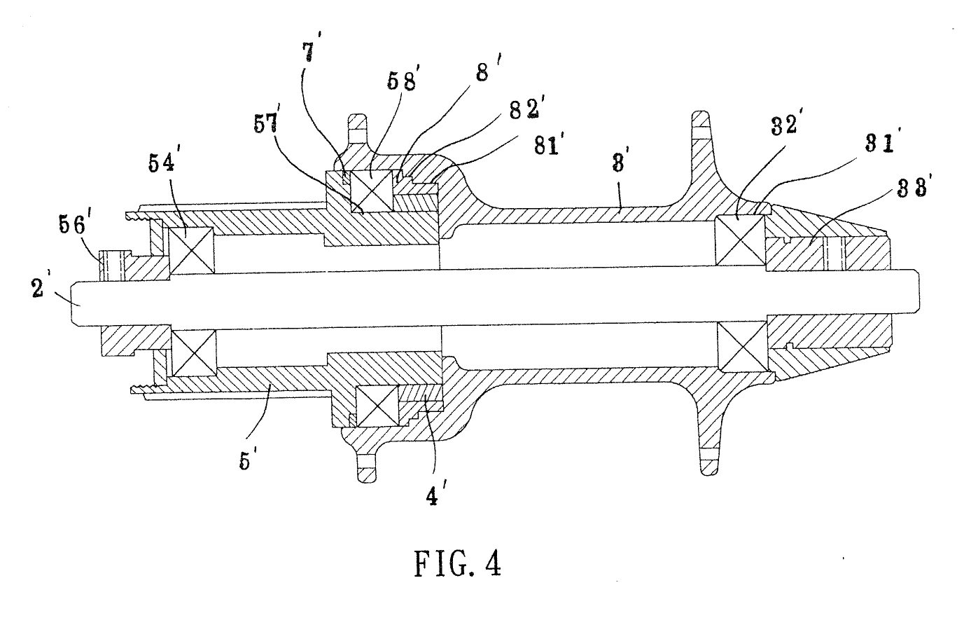

Referring to FIG. 3 and FIG. 4, the bicycle freewheel hub device of the present invention comprises a spindle 2′. Furthermore, a hub 3′, a ratchet 4′, a freewheel 5′, an annular cover 6′, and a sealing washer 7′ are sequentially arranged along the spindle 2′.

One lateral side of the hub 3′ has a groove 31′ for installing a bearing 32′. A fastening component 33′ is installed at an outer portion for securing the bearing 32′ in position. A recess 34′ is disposed in the other end.

The ratchet 4′ consists of a plurality of pawls 41′ which can move upwards and downwards.

The freewheel 5′ has a groove 53′ formed at a position with respect to the inner side of another side of the ratchet 4′ for installing a bearing 54′. A fastening component 56′ serve for securing the bearing 54′ in position.

The annular cover 6′ and the sealing washer 7′ are installed at the opening of the hub 3′.

The feature of the present invention is that a flange 57′ extends from the freewheel 5′ at a position with respect to the inner lateral side of the hub 3′. A bearing 58′ encloses the surface of the outer side of the flange 57 so as to position the ratchet 4′. A recess 34′ is installed at another end of the hub 3′. The inner periphery of the recess is installed with a plurality of retaining grooves 341′ and textured grooves 342′. The inner side of the recess 34′ is arranged with a ratchet ring 8′ which has a plurality of matching ridges 81′ and textured grooves 82′ at the outer circumference thereof. The flange 57′ extending from the freewheel 51 at the position with respect to the inner lateral side of the hub 3′ is engaged with a positioning ratchet pawl 41′. The pawl 41′ is engaged with a ratchet groove 84′. After the bearing 58′ and ratchet 4′ are engaged with the flange 57 at a front end of the freewheel 5′, the flange 57′ at the front end of the freewheel 5′ and the ratchet ring 8′ can be installed in the recess 34′ at one end of the hub 3′.

After above components are assembled, the freewheel-type hub with cogs (not shown) are installed on a bicycle. Since the interior section of the freewheel 5′ extending beyond the flange 57′ and aligned with the hub 3′ serves for installing the sealing washer 7′ and the bearing 58′ as well as the insertion of the ratchet 4′, it resists against the ratchet teeth 83′ inside the ratchet ring 8′. Furthermore, the flange 57′ of the freewheel 5′ and the ratchet ring 8′ can be placed in the recess 34′ of the hub 3′. This enables the freewheel 5′, the ratchet ring 8′, and the hub 3′ are combined into a single structure for suffering the maximum stress at the connection of the freewheel 5′ and the hub 3′. Furthermore, by the flange 57′ of the freewheel 5 and the bearing 58′, the bearing 32′ in the recess 31′ at one end of the hub 3′ and the bearing 54′ in the recess 53′ of the freewheel 5′ cause the reduction of the bearings 55 or 36 of the prior art structure. Therefore, the cost for bearings is reduced and moreover, the weight is decreased. Therefore, in practical operation, the hub can rotate smoothly and the strength of the spindle is increased so that it is difficult to deform the spindle.

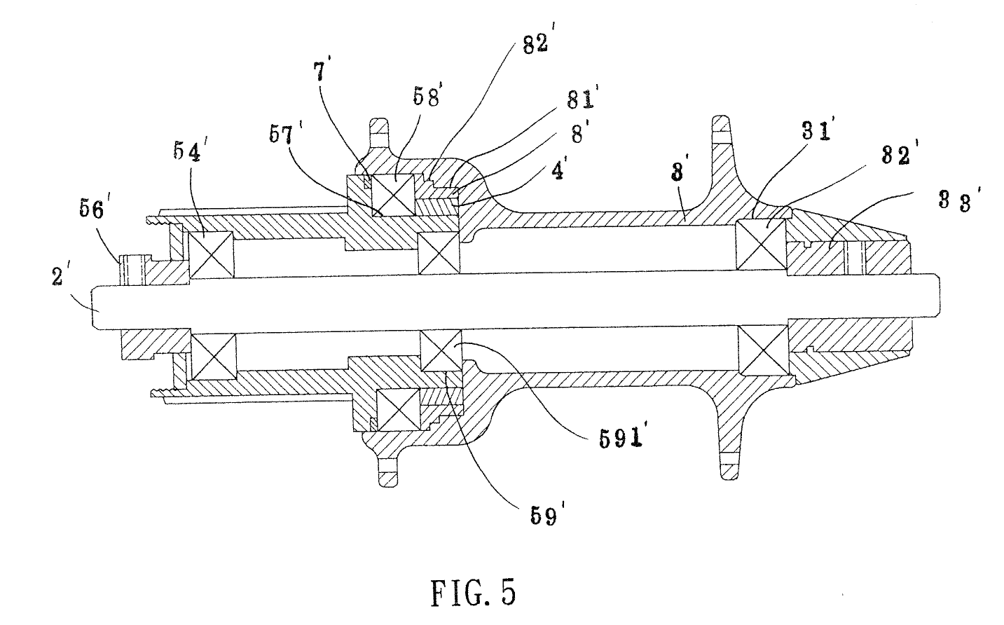

Referring to FIG. 5, a groove 59′ is formed in the freewheel 5′ at a position with respect to the flange 57′ extended from the inner side of the hub 3′. A roller or a ball bearing 591′ can be installed in the recess 59′. Therefore, in practical operation, the hub can rotate smoothly and the strength of the spindle is increased so that it is difficult to deform the spindle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A freewheel hub device having a spindle, further a hub, a ratchet, a freewheel, an annular cover, and a sealing washer being sequentially arranged along the spindle; wherein
one lateral side of the hub has a first groove for installing a first bearing; a first fastening component is installed at an outer portion for securing the first bearing in position; a first recess is disposed in the other end;
the ratchet consists of a plurality of first pawls which is capable of moving upwards and downwards;
the freewheel has a second groove formed at a position with respect to an inner side of the ratchet for installing a second bearing; a second fastening component serves for securing the second bearing in position;
the annular cover and the sealing washer are installed at an opening of the hub;
wherein a flange extends from the freewheel at a position corresponding to an inner lateral side of the hub; a third bearing encloses an surface of the flange so as to position the ratchet; the recess is installed at another end of the hub; an inner periphery of the recess is installed with a plurality of retaining grooves and first texture recesses; an inner side of the recess is arranged with a ratchet ring; the ratchet ring has a plurality of matching ridges and a plurality of second texture recesses at an outer circumference which are engaged with the plurality of retaining grooves and first texture recesses on the inner periphery of the recess; a hollow center of the ratchet ring is formed as a third groove; the flange extending from the freewheel at the position corresponding to the inner lateral side of the hub is engaged with a positioning ratchet pawl; the ratchet ring is engaged with a third groove; after the third bearing and ratchet are engaged with the flange at a front end of the freewheel; the flange at the front end of the freewheel and the ratchet ring are installed in the recess of the hub;
thereby, the cost for bearings is reduced and moreover, the weight is decreased; as a result, in practical operation, the hub rotates smoothly and the strength of the spindle is increased so that it is difficult to deform the spindle.

2. The freewheel hub device of claim 1, wherein a fourth groove is formed in the flange so that the fourth groove receives a rollable bearing; in practical operation, the hub rotates smoothly and the strength of the spindle is increased so that it is difficult to deform the spindle.

3. The freewheel hub device of claim 1, wherein the rollable bearing is one of a roller and a ball bearing.
